(19) United States
(12) Patent Application Publication
(10) Pub. No.: US 2025/0036084 A1
(43) Pub. Date: Jan. 30, 2025

(54) WATCH DISPLAY MEMBER AND WATCH

(71) Applicant: CASIO COMPUTER CO., LTD., Tokyo (JP)

(72) Inventor: Ryo AMIKURA, Tokyo (JP)

(21) Appl. No.: 18/767,522

(22) Filed: Jul. 9, 2024

(30) Foreign Application Priority Data
Jul. 25, 2023 (JP) 2023-120670

(51) Int. Cl. G04B 19/06; G04B 19/20; G04G 9/00

(52) U.S. Cl. CPC G04B 19/06; G04B 19/20; G04G 9/0064; G04G 9/0076

(57) ABSTRACT

A watch display member includes: a first surface and a second surface that are different in inclination angles, wherein a first notation is displayed on the first surface, and a second notation is displayed on the second surface.

### CROSS-REFERENCE TO RELATED APPLICATIONS

This application claims priority to and the benefit of Japanese Patent Application No. 2023-120670 filed on Jul. 25, 2023. The entire specification, claims, and drawings of Japanese Patent Application No. 2023-120670 are incorporated herein by reference.

### TECHNICAL FIELD

The present disclosure relates to a watch display member and a watch.

### BACKGROUND ART

For example, as disclosed in JP 2007-286049 A, known is a wristwatch in which a bezel which is a display member is provided in a body case of a wristwatch case, and each city name of world time, which is a notation, is displayed on the bezel so that the time of each city in the world can be known.

Therefore, if your company concludes that there is no problem with the question of design infringement, it would be helpful if you could contact Mr. Matsuda of KAI directly. Again, as for the design infringement question, it would be helpful if you could give them a brief answer at no cost to them.

A watch display member according to an aspect of the present disclosure includes: a first surface and a second surface that are different in inclination angles, wherein a first notation is displayed on the first surface, and a second notation is displayed on the second surface.

A watch according to another aspect of the present disclosure includes: a watch display member in which a first notation is displayed on a first surface, a second notation is displayed on a second surface, and the first notation and the second notation display a plurality of values determined on the basis of a predetermined standard in a mutually complementary manner.

Further features of the present invention will become apparent from the following description of exemplary embodiments (with reference to the attached drawings).

### BRIEF DESCRIPTION OF THE DRAWINGS

FIG. 1 is an enlarged front view illustrating a first embodiment in which the present invention is applied to a wristwatch;

FIG. 2 is an enlarged cross-sectional view illustrating a main part of the wristwatch illustrated in FIG. 1 in the direction of arrows A-A;

FIG. 3 is an enlarged front view illustrating a second embodiment in which the present invention is applied to a wristwatch; and

FIG. 4 is an enlarged cross-sectional view illustrating a main part of the wristwatch illustrated in FIG. 3 in the direction of arrows B-B.

### DESCRIPTION OF THE EMBODIMENTS

### First Embodiment

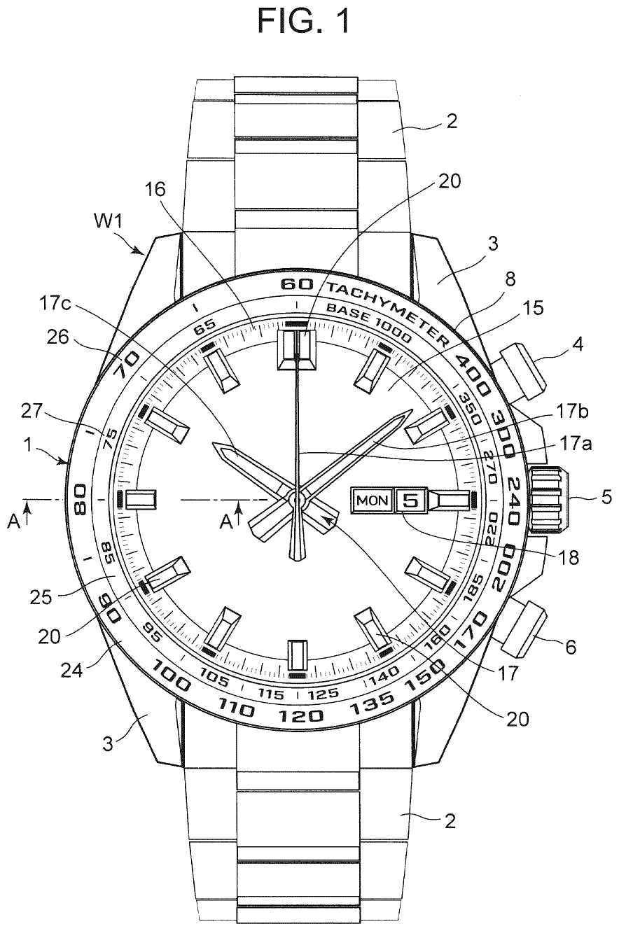

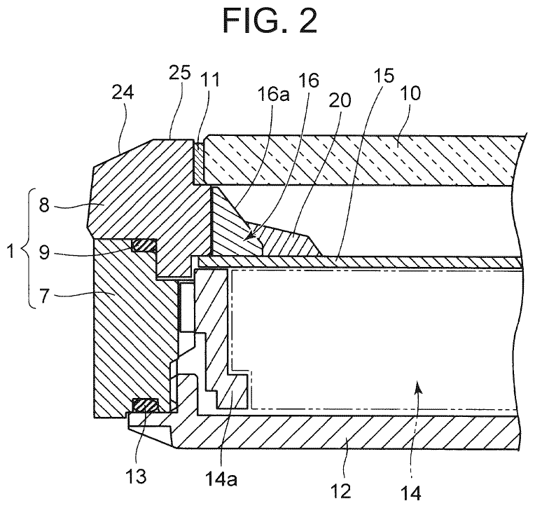

Hereinafter, a first embodiment in which the present invention is applied to a wristwatch will be described with reference to FIGS. 1 and 2.

As illustrated in FIG. 1, a wristwatch W1 includes a case 1. Bracelet attachment portions 3 to which bracelets 2 are attached are provided on the 12 o'clock side and the 6 o'clock side of the case 1, respectively.

As illustrated in FIG. 1, switch devices 4 to 6 are provided on the 2 o'clock side, the 3 o'clock side, and the 4 o'clock side of the case 1, respectively. Among these switch devices 4 to 6, for example, the switch device 4 on the 2 o'clock side is a switch that starts time measurement when the operation mode of the wristwatch W1 is a tachymeter mode. The switch device 5 on the 3 o'clock side is a crown for time correction and the like. The switch device 6 on the 4 o'clock side is a switch for switching the operation mode of the wristwatch W1. The operation mode of the wristwatch W1 may include a stopwatch mode, a world time mode, a timer mode, and the like in addition to the tachymeter mode.

Meanwhile, as illustrated in FIG. 2, the case 1 includes a first case 7 and a second case 8 which is a display member (watch display member). The first case 7 is made of synthetic resin or metal having high rigidity. The second case 8 is a bezel attached to an upper portion of the first case 7 via a first waterproof packing 9. The second case 8 may be made of synthetic resin, but is desirably made of metal such as titanium alloy.

As illustrated in FIG. 2, a watch glass 10 is attached to the upper opening of the case 1, that is, the upper opening of the second case 8 via a glass packing 11. A back cover 12 is attached to the lower portion of the case 1, that is, the lower portion of the first case 7 via a second waterproof packing 13. In addition, a watch module 14 is provided inside the case 1 via an inner frame 14a.

In this case, as illustrated in FIG. 2, a dial 15 is provided on the upper portion of the watch module 14, and a dial ring 16 which is a ring-shaped parting member is disposed between the upper surface of the outer peripheral portion of the dial 15 and the lower surface of the outer peripheral portion of the watch glass 10. That is, the outer peripheral surface of the dial ring 16 is disposed on the inner peripheral surface of the second case 8 in a state where the lower surface of the dial ring 16 is disposed on the upper surface of the outer peripheral portion of the dial 15. The dial ring 16 has a substantially triangular cross-sectional shape, and the inner peripheral surface thereof is formed on an inclined surface 16a.

As illustrated in FIGS. 1 and 2, the watch module 14 includes various components necessary for a watch function such as a watch movement (not illustrated) that moves a pointer 17 such as a second hand 17a, a minute hand 17b, and an hour hand 17c above the dial 15, a display unit 18 that displays information such as a date and a day of the week, and a circuit unit (not illustrated) that drives and controls the watch movement and the display unit 18.

In this case, as illustrated in FIG. 1, the display unit 18 is provided in a region between the central portion of the dial 15 and the 3 o'clock side. As illustrated in FIGS. 1 and 2, hour markers 20 from 1 o'clock to 12 o'clock are provided at equal intervals on the outer peripheral portion of the dial 15. A part of an end portion of each of the plurality of hour markers 20 on the outer peripheral side is disposed on the inclined surface 16a of the dial ring 16.

As illustrated in FIGS. 1 and 2, an outer peripheral side surface 24, which is a first surface, and an inner peripheral side surface 25, which is a second surface, that are different in inclination angles are provided on the upper surface of the second case 8 which is a display member of the case 1. A first notation 26 and a second notation 27 of a tachymeter are displayed on the outer peripheral side surface 24 and the inner peripheral side surface 25, respectively. The tachymeter measures average speed of a traveling body such as a vehicle on the basis of a rotation angle of a hand that has moved during a time taken for the traveling body to travel a predetermined distance, for example, 1 Km.

As illustrated in FIGS. 1 and 2, the outer peripheral side surface 24 and the inner peripheral side surface 25 are each formed in a circular ring shape, and the outer peripheral side surface 24 is concentrically disposed outside the inner peripheral side surface 25. The outer peripheral side surface 24 is inclined at a visible angle with respect to a viewing direction. That is, the outer peripheral side surface 24 is formed on an inclined surface which is gradually lower in height from the inner periphery toward the outer periphery. On the other hand, the inner peripheral side surface 25 is formed on a plane surface orthogonal to the viewing direction.

As a result, in the second case 8 of the case 1 of the wristwatch W1, since the outer peripheral side surface 24 which is the first surface is an inclined surface and the inner peripheral side surface 25 which is the second surface is a horizontal plane surface, both the first notation 26 of the outer peripheral side surface 24 and the second notation 27 of the inner peripheral side surface 25 can be visually recognized when the wristwatch W1 is seen from the front of the case 1, so that the visibility of the first notation 26 and the second notation 27 can also be improved.

As illustrated in FIG. 1, the first notation 26 of the tachymeter is displayed on the outer peripheral side surface 24 which is the first surface. In addition, the second notation 27 of the tachymeter is displayed on the inner peripheral side surface 25 which is the second surface. In this case, in each of the first notation 26 and the second notation 27, numerals used in the tachymeter mode are engraved and displayed.

That is, both the first notation 26 and the second notation 27 are notations indicating values determined on the basis of a predetermined standard, the first notation 26 and the second notation 27 include a plurality of values different from each other, and these values are arranged on the outer peripheral side surface 24 and the inner peripheral side surface 25 in descending order in the clockwise direction. As a result, the first notation 26 and the second notation 27 display a plurality of values determined on the basis of a predetermined standard in a mutually complementary manner, so that the plurality of values determined on the basis of the predetermined standard can be displayed correctly by the first notation 26 and the second notation 27.

That is, in the first notation 26, as illustrated in FIG. 1, numerals representing time are displayed in a predetermined scale unit. In addition, in the second notation 27, a numeral representing time is a middle numeral between the plurality of numerals of the first notation 26, and is displayed corresponding to each middle between the plurality of numerals of the first notation 26. In this case, numerals of the first notation 26 are displayed more largely than numerals of the second notation 27. In addition, numerals of the first notation 26 are displayed more thickly than numerals of the second notation 27.

In addition, the outer peripheral side surface 24 and the inner peripheral side surface 25 are subjected to different types of surface treatment. For example, the outer peripheral side surface 24 may be subjected to radial hairline treatment, and the inner peripheral side surface 25 may be subjected to circumferential hairline treatment orthogonal to a radial direction. In addition, for example, the outer peripheral side surface 24 may be subjected to hairline treatment, and the inner peripheral side surface 25 may be subjected to mirror surface treatment or satin finishing treatment. That is, the outer peripheral side surface 24 and the inner peripheral side surface 25 only need to be subjected to different types of surface treatment by combining the above-described various types of surface treatment.

In other words, a ridge line is formed and interposed between the outer peripheral side surface 24 and the inner peripheral side surface 25 on the surface of the second case 8. Since this ridge line is visually recognized as a boundary line between the first notation 26 and the second notation 27, the first notation 26 displayed on the outer peripheral side surface 24 and the second notation 27 displayed on the inner peripheral side surface 25 can be easily distinguished from each other, can be easily seen, and the visibility can be improved.

Next, the operation of such a wristwatch W1 will be described.

In the case of using the wristwatch W1, first, the case 1 is attached to the arm with the bracelet 2. In this state, in general, the pointer 17 such as the second hand 17a, the minute hand 17b, and the hour hand 17c moves above the dial 15 to indicate the hour marker 20 on the dial 15 and the scale of the dial ring 16, whereby the current time is indicated and displayed.

In this state, for example, in a case where the average speed of a traveling body such as a vehicle is measured by the tachymeter, first, the switch device 6 is operated a required number of times to select the tachymeter mode. Then, the second hand 17a stops toward the 12 o'clock direction in the initial state. Thereafter, when the switch device 4 is operated once, the second hand 17a starts a hand movement at a predetermined rotation speed (for example, a pace of one round per minute) from the 12 o'clock position.

Then, when the switch device 4 is operated again when the traveling body such as a vehicle travels a predetermined distance, for example, 1 Km, the second hand 17a is stopped. Then, the hand movement by the second hand 17a is stopped and the first notation 26 of the outer peripheral side surface 24 and the second notation 27 of the inner peripheral side surface 25 displayed on the upper surface of the second case 8 which is a display member, are indicated.

As a result, the average speed of the traveling body such as a vehicle when the traveling body travels a predetermined distance (for example, 1 Km) is calculated by a numeral or a scale displayed on the first notation 26 of the outer peripheral side surface 24 and the second notation 27 of the inner peripheral side surface 25 and indicated by the second hand 17a.

In this case, the outer peripheral side surface 24 and the inner peripheral side surface 25 are each formed in a circular shape on the upper surface of the second case 8 which is a display member, and the outer peripheral side surface 24 is concentrically disposed outside the inner peripheral side surface 25. As a result, the first notation 26 of the outer peripheral side surface 24 and the second notation 27 of the inner peripheral side surface 25 are displayed in a double manner, that is, in two rows. For this reason, numerals of the first notation 26 representing time and numerals of the second notation 27 representing time are displayed largely and are easy to see.

Here, in the wristwatch disclosed in JP 2007-286049 A described above, the bezel which is a display member is divided into an outer ring-shaped region and an inner ring region in the radial direction of the ring on one upper surface of the ring-shaped bezel, and each city name is engraved thereon. However, in a portion where the engraving of the outer ring-shaped region and the engraving of the inner ring region are adjacent to each other, these engravings appear to be united together, and the visibility is poor. On the other hand, the outer peripheral side surface 24 is inclined with respect to the viewing direction. That is, the outer peripheral side surface 24 is formed on an inclined surface which is gradually lower in height from the inner periphery toward the outer periphery, and the inner peripheral side surface 25 is formed on a horizontal plane surface. As a result, the boundary line between the outer peripheral side surface 24 and the inner peripheral side surface 25 can be easily visually recognized due to a difference in the physical angles therebetween. Therefore, even if the first notation 26 of the outer peripheral side surface 24 and the second notation 27 of the inner peripheral side surface 25 are disposed close to each other, it is possible to reduce the possibility of erroneously recognizing a numerical value due to these notations being recognized as a united notation, and the visibility of each of the first notation 26 and the second notation 27 is improved.

In addition, in the first notation 26 of the outer peripheral side surface 24, a displayed numeral is displayed in a predetermined scale unit, and in the second notation 27 of the inner peripheral side surface 25, a displayed numeral is a middle numeral between the plurality of numerals of the first notation 26, and is displayed corresponding to the middle between the numerals of the first notation 26. Therefore, even when the position indicated by the second hand 17a is between numerals of one of the first notation 26 or the second notation 27, it is possible to know a more accurate numeral (average speed of traveling body) by numerals of the other notation. Therefore, it is possible to indicate the average speed of the traveling body more accurately as compared with a case where there are only numerals of one of the notations.

In addition, since the outer peripheral side surface 24 and the inner peripheral side surface 25 are concentric, and the outer peripheral side surface 24 is disposed outside the inner peripheral side surface 25, the circumference of the outer peripheral side surface 24 is longer. Since the outer peripheral side surface 24 has a longer circumference than the inner peripheral side surface 25, the width of a numeral of the first notation 26 can be wider in the circumferential direction than the width of a numeral of the second notation 27. The first notation 26 of the outer peripheral side surface 24 has a wider character width in a limited space, so that the visibility of the first notation 26 can be improved.

On the contrary, the width of a numeral of the second notation 27 can be narrower in the circumferential direction than the width of a numeral of the first notation 26. The second notation 27 of the inner peripheral side surface 25 has a narrower character width in a limited space, so that the visibility can be improved by appropriately maintaining the interval between the second notations 27 while displaying more of the second notations 27.

In addition, since the outer peripheral side surface 24 on which the first notation 26 is displayed and the inner peripheral side surface 25 on which the second notation 27 is displayed are subjected to different types of surface treatment, the boundary line between the outer peripheral side surface 24 and the inner peripheral side surface 25 can be easily visually recognized due to a difference in the surface treatment. Therefore, even if the first notation 26 of the outer peripheral side surface 24 and the second notation 27 of the inner peripheral side surface 25 are disposed close to each other, it is possible to reduce the possibility of erroneously recognizing a numerical value due to these notations being recognized as a united notation, and the visibility of each of the first notation 26 and the second notation 27 is improved.

In addition, in the second case 8 of the case 1 of the wristwatch W1, the outer peripheral side surface 24 which is the first surface and the inner peripheral side surface 25 which is the second surface are each circular-shaped, and the outer peripheral side surface 24 is concentrically disposed outside the inner peripheral side surface 25, so that the first notation 26 and the second notation 27 can be displayed in a double manner, that is, in two rows. As a result, as compared with a case where the first notation 26 and the second notation 27 are all displayed in one row, each numeral can be displayed more largely, and the visibility can be improved.

On the contrary, since it is not possible to display all the numerals of the first notation 26 and the second notation 27 in one row while maintaining the size of the numerals, in a case where priority is given to the size of the numerals in order to maintain the visibility, only some of the numerals of the first notation 26 and the second notation 27 are displayed, which may impair convenience.

In addition, since the outer peripheral side surface 24 on which the first notation 26 is displayed and the inner peripheral side surface 25 on which the second notation 27 is displayed are subjected to different types of surface treatment, the decorativeness of the case 1 is improved, whereby the appearance and the design of the entire wristwatch can be improved.

For example, the outer peripheral side surface 24 is subjected to the radial hairline treatment, and the inner peripheral side surface 25 is subjected to the circumferential hairline treatment orthogonal to the radial direction, so that the decorativeness and the design of the case 1 are improved. Similarly, for example, the outer peripheral side surface 24 is subjected to the hairline treatment, and the inner peripheral side surface 25 is subjected to the mirror surface treatment or the satin finishing treatment, so that the decorativeness and the design of the case 1 are improved. That is, the outer peripheral side surface 24 and the inner peripheral side surface 25 are subjected to the various types of surface treatment described above in combination, so that the decorativeness and the design of the case 1 are improved.

Note that, in the first embodiment described above, the case where the inner peripheral side surface 25, which is the second surface provided on the upper surface of the second case 8, which is a display member, is formed on a horizontal plane surface has been described, but the present invention is not limited thereto, and the inner peripheral side surface 25 may be formed on an inclined surface. In this case, the inner peripheral side surface 25 which is the second surface may be an inclined surface which is gradually higher in height from the inner periphery toward the outer periphery, or may be an inclined surface which is gradually lower in height from the inner periphery toward the outer periphery at an inclination angle gentler than the inclination angle of the outer peripheral side surface 24 which is the first surface.

In addition, in the first embodiment described above, the case where the first notation 26 displayed on the outer peripheral side surface 24 and the second notation 27 displayed on the inner peripheral side surface 25 are numerals representing the speed of the tachymeter has been described, but the present invention is not limited thereto, and for example, the first notation of the outer peripheral side surface 24 and the second notation of the inner peripheral side surface 25 may be the names of cities in the world in world time.

### Second Embodiment

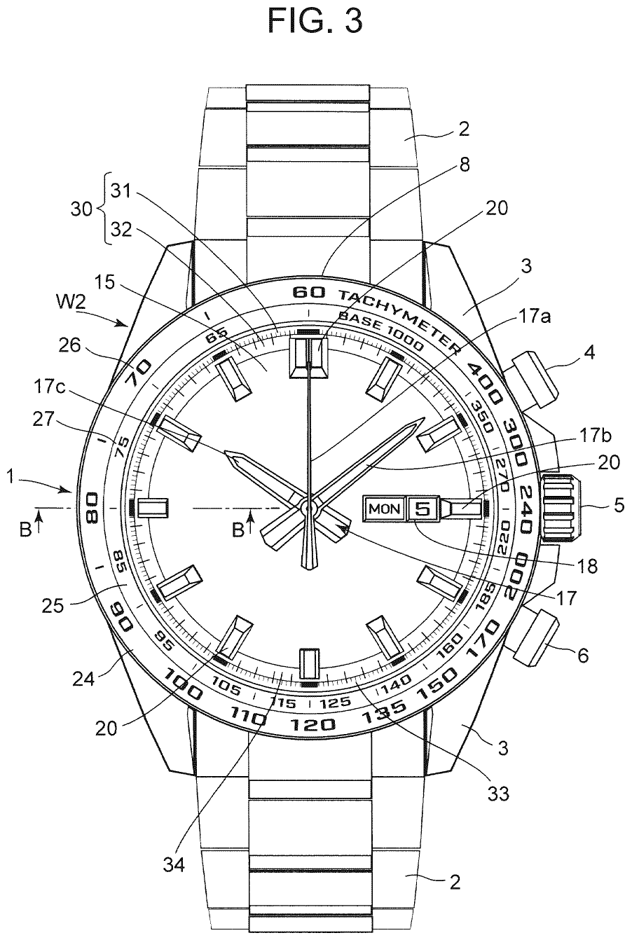

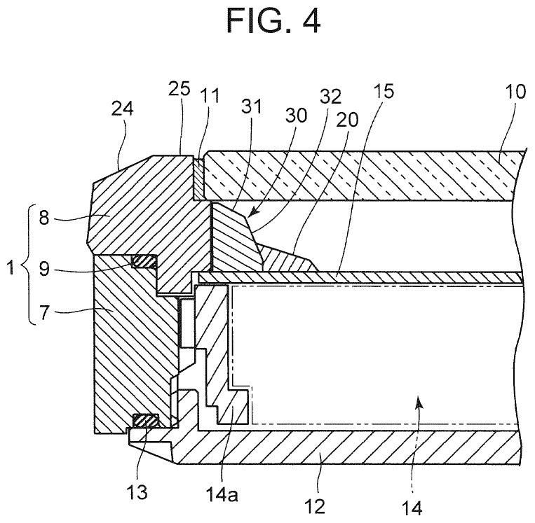

Next, a second embodiment in which the present invention is applied to a wristwatch will be described with reference to FIGS. 3 and 4. In this case, the same portions as those of the first embodiment illustrated in FIGS. 1 and 2 will be denoted by the same reference signs.

As illustrated in FIGS. 3 and 4, a wristwatch W2 according to the second embodiment is a dial ring 30 which is a parting member in which a display member is provided on the outer peripheral portion of the dial 15 of the case 1. The structures other than this structure are substantially the same as those of the first embodiment.

As illustrated in FIGS. 3 and 4, the dial ring 30 may be made of synthetic resin, but is desirably made of metal such as titanium alloy. In addition, the dial ring 30 includes an outer peripheral side surface 31 which is a first surface and an inner peripheral side surface 32 which is a second surface that are different in inclination angles from each other. In this case, the outer peripheral side surface 31 and the inner peripheral side surface 32 are each formed in a circular ring shape, and the outer peripheral side surface 31 is concentrically disposed outside the inner peripheral side surface 32.

As illustrated in FIGS. 3 and 4, the outer peripheral side surface 31 and the inner peripheral side surface 32 are each inclined at an angle visually recognizable with respect to the viewing direction. That is, the outer peripheral side surface 31 is formed on a first inclined surface inclined at a gentle inclination angle such that the height is gradually decreased from the outer periphery toward the inner periphery. The inner peripheral side surface 32 is formed on a second inclined surface inclined at a steep inclination angle larger than the inclination angle of the first inclined surface such that the height is steeply decreased from the outer periphery toward the inner periphery. As a result, the boundary line between the outer peripheral side surface 31 and the inner peripheral side surface 32 can be easily visually recognized due to a difference in the physical angle therebetween.

In addition, as illustrated in FIGS. 3 and 4, on the outer peripheral side surface 31 which is the first surface and the inner peripheral side surface 32 which is the second surface, a first notation 33 and a second notation 34 are displayed, respectively. In this case, the first notation 33 and the second notation 34 represent time. That is, the second notation 34 of the inner peripheral side surface 32 is a part of the end portion on the outer peripheral side of each of the plurality of hour markers 20 indicating 1 o'clock to 12 o'clock.

As a result, even if the first notation 33 of the outer peripheral side surface 31 and the second notation 34 of the inner peripheral side surface 32 are disposed close to each other, the boundary line between the outer peripheral side surface 31 and the inner peripheral side surface 32 can be easily visually recognized due to a difference in the physical angle therebetween. Therefore, it is possible to reduce the possibility of erroneously recognizing a numerical value due to the first notation 33 and the second notation 34 being recognized as a united notation, and the visibility of each of the first notation 33 and the second notation 34 is improved.

As illustrated in FIG. 3, the first notation 33 is a scale displayed corresponding to each interval between the plurality of hour markers 20 from 1 o'clock to 12 o'clock of the second notation 34 of the inner peripheral side surface 32. As a result, the hour marker 20 of the second notation 34 is displayed more largely than the scale of the first notation 33. In addition, the hour marker 20 of the second notation 34 is displayed more thickly than the scale of the first notation 33.

Therefore, even when the position indicated by the pointer 17 such as the second hand 17a, the minute hand 17b, and the hour hand 17c is between the hour markers 20 of the first notation 33, it is possible to know more accurate time by the scale of the second notation 34. Therefore, it is possible to indicate the current time more accurately as compared with a case where there is only one of these notations.

In addition, the outer peripheral side surface 31 which is the first surface and the inner peripheral side surface 32 which is the second surface are subjected to different types of surface treatment, similarly to the first embodiment. For example, the outer peripheral side surface 31 may be subjected to radial hairline treatment, and the inner peripheral side surface 32 may be subjected to circumferential hairline treatment orthogonal to the radial direction. In addition, for example, the outer peripheral side surface 31 may be subjected to the hairline treatment, and the inner peripheral side surface 32 may be subjected to the mirror surface treatment or the satin finishing treatment. That is, the outer peripheral side surface 31 and the inner peripheral side surface 32 only need to be subjected to different types of surface treatment by combining the various types of surface treatment described above.

According to the dial ring 30 which is the display member of the wristwatch W2 of the second embodiment, the outer peripheral side surface 31, which is the first surface, and the inner peripheral side surface 32, which is the second surface, that are different in inclination angles are provided, the first notation 33 is displayed on the outer peripheral side surface 31, and the second notation 34 is displayed on the inner peripheral side surface 32. Therefore, similarly to the first embodiment, since the outer peripheral side surface 31 and the inner peripheral side surface 32 are inclined at different inclination angles, the first notation 33 displayed on the outer peripheral side surface 31 and the second notation 34 displayed on the inner peripheral side surface 32 can be easily distinguished from each other, and can be visually recognized in an appropriate manner, whereby the visibility can be improved.

In this case, in the dial ring 30 of the wristwatch W2, the outer peripheral side surface 31 which is the first surface and the inner peripheral side surface 32 which is the second surface are each circular-shaped, and the outer peripheral side surface 31 is concentrically disposed outside the inner peripheral side surface 32, similarly to the first embodiment, so that the first notation 33 and the second notation 34 can be displayed in a double manner, that is, in two rows. As a result, as compared with a case where the first notation 33 and the second notation 34 are displayed in one row, each numeral can be displayed largely.

In addition, in the dial ring 30 of the wristwatch W2, since the outer peripheral side surface 31 which is the first surface and the inner peripheral side surface 32 which is the second surface are inclined at different inclination angles with respect to the viewing direction, the first notation 33 and the second notation 34 displayed on the outer peripheral side surface 31 and the inner peripheral side surface 32, respectively, can be easily distinguished from each other and can be easily seen. As a result, the visibility can be improved.

That is, in the dial ring 30 of the wristwatch W2, the outer peripheral side surface 31 which is the first surface is formed on the first inclined surface gently inclined, and the inner peripheral side surface 32 which is the second surface is formed on the second inclined surface more steeply inclined than the outer peripheral side surface 31, so that the second notation 34 of the inner peripheral side surface 32 and the first notation 33 of the outer peripheral side surface 31 can be identified and easily seen. As a result, the visibility of each of the first notation 33 and the second notation 34 can also be improved.

In addition, in the dial ring 30 of the wristwatch W2, the second notation 34 displayed on the inner peripheral side surface 32 which is the second surface is displayed more largely and thickly than the first notation 33 displayed on the outer peripheral side surface 31 which is the first surface, so that the second notation 34, which is a part of the end portion on the outer peripheral side of the hour marker 20 displayed on the inner peripheral side surface 32, and the first notation 33, which is the scale displayed on the outer peripheral side surface 31, can be identified and easily seen. As a result, the visibility of each of the first notation 33 and the second notation 34 can also be improved.

For this reason, the rough time can be quickly recognized by the hour marker 20 of the second notation 34 indicated by the pointer 17, and the accurate time can be recognized by the scale of the first notation 33. As a result, the visibility can also be improved.

In addition, in the dial ring 30 of the wristwatch W2, the outer peripheral side surface 31 which is the first surface and the inner peripheral side surface 32 which is the second surface are subjected to different types of surface treatment, similarly to the first embodiment, so that the decorativeness of the dial ring 30 can be improved. As a result, the appearance and the design of the entire wristwatch W2 can be improved.

In this case, the outer peripheral side surface 31 may be subjected to radial hairline treatment, and the inner peripheral side surface 32 may be subjected to circumferential hairline treatment orthogonal to the radial direction. Alternatively, the outer peripheral side surface 31 may be subjected to the hairline treatment, and the inner peripheral side surface 32 may be subjected to mirror surface treatment or satin finishing treatment. That is, the outer peripheral side surface 31 and the inner peripheral side surface 32 are subjected to the various types of surface treatment described above in combination, whereby the decorativeness and the design of the entire wristwatch W2 can be further improved.

Note that, in the second embodiment described above, the case where the outer peripheral side surface 31 which is the first surface and the inner peripheral side surface 32 which is the second surface of the dial ring 30 which is the display member are formed on the first inclined surface and the second inclined surface inclined at different inclination angles has been described, but the present invention is not limited thereto, and for example, the outer peripheral side surface 31 which is the first surface may be formed on a horizontal plane surface.

In addition, in the first embodiment and the second embodiment described above, the case where the present invention is applied to the wristwatches W1 and W2 has been described, but the present invention is not necessarily applied to a wristwatch, and can be applied to various watches such as a travel watch, an alarm clock, a table clock, and a wall clock. In addition, the present invention is not necessarily applied to a watch, and can also be applied to an electronic device such as an arm-worn device or a portable information terminal to be used by being worn on the arm.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-120670, filed Jul. 25, 2023 which is hereby incorporated by reference wherein in its entirety.

What is claimed is:

1. A watch display member comprising:
a first surface and a second surface that are different in inclination angles, wherein
a first notation is displayed on the first surface, and
a second notation is displayed on the second surface.

2. The watch display member according to claim 1, wherein
the first notation and the second notation display a plurality of values determined on a basis of a predetermined standard in a mutually complementary manner.

3. The watch display member according to claim 1, wherein
the first surface is concentrically disposed outside the second surface.

4. The watch display member according to claim 1, wherein
at least one of the first surface and the second surface is inclined with respect to a viewing direction.

5. The watch display member according to claim 3, wherein
one of the first surface and the second surface is orthogonal to a viewing direction.

6. The watch display member according to claim 1, wherein
the first notation displayed on the first surface and the second notation displayed on the second surface are displayed in different sizes.

7. The watch display member according to claim 1, wherein
the first surface and the second surface are subjected to different types of surface treatment.

8. A watch comprising the watch display member according to claim 1.

9. The watch according to claim 8, wherein
the watch display member is a bezel or a dial ring.

10. The watch according to claim 8, wherein
a plurality of values of the first notation and the second notation is speed of a tachymeter, time of a watch, or names of cities in the world in world time.

11. A watch comprising:
a watch display member in which a first notation is displayed on a first surface, a second notation is displayed on a second surface, and the first notation and the second notation display a plurality of values determined on a basis of a predetermined standard in a mutually complementary manner.

12. The watch according to claim 11, wherein
a ridge line formed on a surface of the watch display member is interposed between the first surface and the second surface.

13. The watch according to claim 11, wherein
the first surface and the second surface are two surfaces that are different in inclination angles with respect to a viewing direction of the watch.
